(19) United States
(12) Patent Application Publication
(10) Pub. No.: US 2026/0001751 A1
(43) Pub. Date: Jan. 1, 2026

(54) BATTERY MODULE LIFTING TOOL

(71) Applicant: GM Global Technology Operations LLC, Detroit, MI (US)

(72) Inventors: Owen Rauch, Howell, MI (US); Johnny Brown, Fort Gratiot, MI (US); James Ronald Glefke, JR., Richmond, MI (US)

(73) Assignee: GM Global Technology Operations LLC, Detroit, MI (US)

(21) Appl. No.: 18/757,837

(22) Filed: Jun. 28, 2024

(51) Int. Cl. B66F 11/00; H01M 50/249; H01M 50/256; H01M 50/258

(52) U.S. Cl. CPC B66F 11/00; H01M 50/249; H01M 50/256; H01M 50/258; H01M 2220/20

(57) ABSTRACT

A lifting tool for battery modules for electric vehicles includes a support arm having a first distal end and a second distal end, the first distal end including features adapted for attachment to a lifting mechanism, and a chassis supported on the second distal end of the support arm and including a plurality of lifting hooks adapted to engage engagement features of battery modules for electric vehicles, wherein, each of the plurality of lifting hooks is adapted to engage battery modules having first engagement features, and adapted to engage battery modules having second engagement features.

### INTRODUCTION

The present invention relates generally to a tool for lifting battery modules for electric vehicles.

Different generations and different applications of similar battery modules for use in electric vehicles have unique lifting points, and thus, require lifting tools with unique lifting hooks, requiring use of a different lifting tool for various battery modules.

Thus, while current lifting tools achieve their intended purpose, there is a need for a new and improved battery module lifting tool that is adapted for use with multiple variations of battery modules having unique lifting points.

### SUMMARY

According to several aspects, a lifting tool for battery modules for electric vehicles includes a support arm having a first distal end and a second distal end, the first distal end including features adapted for attachment to a lifting mechanism, and a chassis supported on the second distal end of the support arm and including a plurality of lifting hooks adapted to engage engagement features of battery modules for electric vehicles, wherein, each of the plurality of lifting hooks is adapted to engage battery modules having first engagement features, and adapted to engage battery modules having second engagement features.

According to another aspect, the chassis is pivotally supported on the second distal end of the support arm to allow the chassis to align with an orientation of a battery module.

According to another aspect, the plurality of lifting hooks includes at least one left side lifting hook and at least one right side lifting hook, the at least one left side lifting hook and the at least one right side lifting hook oriented facing one another and adapted to engage the engagement features of a battery module therebetween.

According to another aspect, the at least one left side lifting hook is laterally moveable relative to the at least one right side lifting hook, wherein the at least one left side lifting hook is adapted to be selectively moved away from the at least one right side lifting hook to allow the lifting tool to be positioned onto a battery module, and selectively moved toward the at least one right side lifting hook bringing the plurality of lifting hooks into vertical alignment with engagement features of the battery module once the lifting tool is positioned onto the battery module, wherein, when the lifting tool is raised upward the plurality of lifting hooks engage the engagement features of the battery module.

According to another aspect, the lifting tool further includes a lever mechanism adapted to allow selective movement of the at least one left side lifting hook relative to the at least one right side lifting hook.

According to another aspect, the plurality of lifting hooks are adapted to engage the engagement features of a battery module such that the plurality of lifting hooks cannot be disengaged from the battery module and the battery module cannot move within the lifting tool when the weight of the battery module is being supported by the plurality of lifting hooks.

According to another aspect, the plurality of lifting hooks are electrically isolated from the chassis of the lifting tool.

According to another aspect, the lifting tool further includes a plurality of isolating elements, one isolating element positioned between each of the plurality of lifting hooks and the chassis and each of the plurality of isolating elements made from a non-conductive material.

According to another aspect, the plurality of isolating elements are made from a polymer material.

According to another aspect, the plurality of lifting hooks includes a first lifting hook, a second lifting hook, a third lifting hook and a fourth lifting hook, wherein the first lifting hook and the second lifting hook are right side lifting hooks, the third lifting hook and the fourth lifting hook are left side lifting hooks, and the second lifting hook and the fourth lifting hook are mirror images of the first lifting hook and the third lifting hook.

According to another aspect, each of the plurality of lifting hooks includes a body including features adapted to allow the lifting hook to be attached to one of the plurality of isolating elements, an upward lip portion extending laterally along a bottom edge of the lifting hook, the lip portion including a pair of notches formed therein, the notches defining a center lip section, wherein, first engagement features of a battery module include a bumped out portion of a module cover, and when the lifting hook engages the bumped out portion of the module cover, the center lip section is received within the bumped out portion of the module cover, preventing lateral movement of the lifting hook away from the battery module when the weight of the battery module is supported on the lifting hook, and, preventing movement of the battery module fore and aft within the lifting tool, thereby locking the battery module within the plurality of lifting hooks and preventing the battery module from being dislodged from the lifting tool.

According to another aspect, each of the plurality of lifting hooks further includes a ramped section formed within the lip portion near a distal end of the lifting hook and defining a tapered hub adjacent the distal end of the lifting hook, wherein, second engagement features of a battery module include a downward lip flange extending from a side wall of the battery module, and when the lifting hook engages the second engagement features of the side wall of the battery module, the tapered hub is engaged with the downward lip flange, wherein engagement of the upward lip of the lifting hook with the downward lip flange of the battery module prevents lateral movement of the lifting hook away from the battery module when the weight of the battery module is supported on the lifting hook, and, the tapered hub, engaged with the downward lip flange prevents movement of the battery module fore and aft within the lifting tool, thereby locking the battery module within the plurality of lifting hooks and preventing the battery module from being dislodged from the lifting tool.

According to several aspects of the present disclosure, a method of utilizing a lifting tool for battery modules for electric vehicles includes attaching a first distal end of a support arm of the lifting tool to a lifting mechanism, and engaging engagement features of a battery module with a plurality of lifting hooks mounted onto a chassis that is supported on a second distal end of the support arm, wherein, each of the plurality of lifting hooks is adapted to engage battery modules having first engagement features, and adapted to engage battery modules having second engagement features.

According to another aspect, the engaging engagement features of a battery module with a plurality of lifting hooks mounted onto a chassis that is supported on a second distal end of the support arm further includes aligning the chassis with an orientation of the battery module via a pivotal connection between the chassis and the second distal end of the support arm.

According to another aspect, the plurality of lifting hooks includes at least one left side lifting hook and at least one right side lifting hook, the at least one left side lifting hook and the at least one right side lifting hook oriented facing one another and adapted to engage the engagement features of a battery module therebetween, wherein the at least one left side lifting hook is laterally moveable relative to the at least one right side lifting hook, the engaging engagement features of a battery module with a plurality of lifting hooks mounted onto a chassis that is supported on a second distal end of the support arm further including selectively moving the at least one left side lifting hook away from the at least one right side lifting hook to allow the lifting tool to be positioned onto a battery module, lowering the lifting tool onto the battery module, selectively moving the at least one left side lifting hook toward the at least one right side lifting hook and bringing the plurality of lifting hooks into vertical alignment with engagement features of the battery module, and raising the lifting tool upward and engaging the plurality of lifting hooks with the engagement features of the battery module.

According to another aspect, the selectively moving the at least one left side lifting hook further includes selectively moving the at least one left side lifting hook by selectively actuating a lever mechanism adapted to move the at least one left side lifting hook relative to the at least one right side lifting hook.

According to another aspect, the method further includes positioning an isolating element, made from a non-conductive polymer material, between each of the plurality of lifting hooks and the chassis.

According to another aspect, the plurality of lifting hooks includes a first lifting hook, a second lifting hook, a third lifting hook and a fourth lifting hook, wherein the first lifting hook and the second lifting hook are right side lifting hooks, the third lifting hook and the fourth lifting hook are left side lifting hooks, and the second lifting hook and the fourth lifting hook are mirror images of the first lifting hook and the third lifting hook, each of the plurality of lifting hooks including a body including features adapted to allow the lifting hook to be attached to an isolating element and an upward lip portion extending laterally along a bottom edge of the lifting hook, the lip portion including a pair of notches formed therein, the notches defining a center lip section, wherein, the raising the lifting tool upward and engaging the plurality of lifting hooks with engagement features of a battery module further includes raising the lifting tool upward, and for each of the plurality of lifting hooks, receiving, within first engagement features that include a bumped out portion of a module cover of the battery module, the center lip section of the lifting hook, thereby preventing lateral movement of the lifting hook away from the battery module when the weight of the battery module is supported on the lifting hook, and, preventing movement of the battery module fore and aft within the lifting tool, thereby locking the battery module within the plurality of lifting hooks and preventing the battery module from being dislodged from the lifting tool.

According to another aspect, each of the plurality of lifting hooks further includes a ramped section formed within the lip portion near a distal end of the lifting hook and defining a tapered hub adjacent the distal end of the lifting tool, wherein, the raising the lifting tool upward and engaging the plurality of lifting hooks with engagement features of a battery module further includes raising the lifting tool upward, and for each of the plurality of lifting hooks, engaging, with second engagement features including a downward lip flange extending from a side wall of the battery module, the tapered hub, engaging the upward lip of the lifting hook with the downward lip flange of the battery module and preventing lateral movement of the lifting hook away from the battery module when the weight of the battery module is supported on the lifting hook, and preventing, with the tapered hub engaged with the downward lip flange, movement of the battery module fore and aft within the lifting tool, thereby locking the battery module within the plurality of lifting hooks and preventing the battery module from being dislodged from the lifting tool.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a lifting tool according to an exemplary embodiment of the present disclosure;

FIG. 2 is a perspective view of the lifting tool shown in FIG. 1, wherein the lifting tool is clamped onto a battery module;

FIG. 3 is a close-up view of the left side lifting hooks clamped onto the battery module shown in FIG. 2;

FIG. 4A is a perspective view of a first lifting hook and a third lifting hook of the lifting tool shown in FIG. 1 and FIG. 2;

FIG. 4B is a perspective view of a second lifting hook and a fourth lifting hook of the lifting tool shown in FIG. 1 and FIG. 2;

FIG. 5A is a schematic illustration showing a lifting tool located in proximity above a battery module;

FIG. 5B is a schematic illustration showing the left side lifting hooks of the lifting tool moving away from the right side lifting hooks of the lifting tool shown in FIG. 5A;

FIG. 5C is a schematic illustration showing the lifting tool being lowered onto the battery module;

FIG. 5D is a schematic illustration showing the left side lifting hooks of the lifting tool moving toward the right side lifting hooks of the lifting tool shown in FIG. 5A;

FIG. 5E is a schematic illustration showing the lifting tool being raised and the lifting hooks engaging engagement features of the battery module;

FIG. 6A is a perspective view of a lifting hook aligned with first engagement features of a battery module;

FIG. 6B is a perspective view of a lifting hook engaging with first engagement features of a battery module;

FIG. 6C is an end view of a lifting hook engaged with first engagement features of a battery module;

FIG. 6D is a sectional view of the lifting hook engaged with first engagement features of the battery module shown in FIG. 60;

FIG. 7 is a perspective view of a lifting hook engaged with second engagement features of a sidewall of a battery module;

FIG. 8 is a schematic perspective view of the downward flange of the second engagement features of the battery module shown in FIG. 7 engaged with the lifting hook; and

FIG. 9 is a flow chart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of”. Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

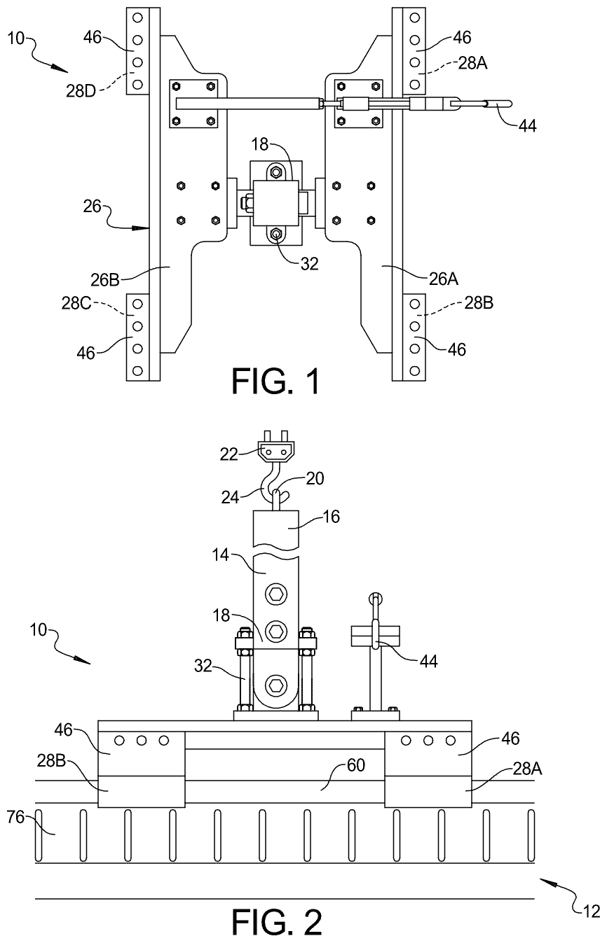

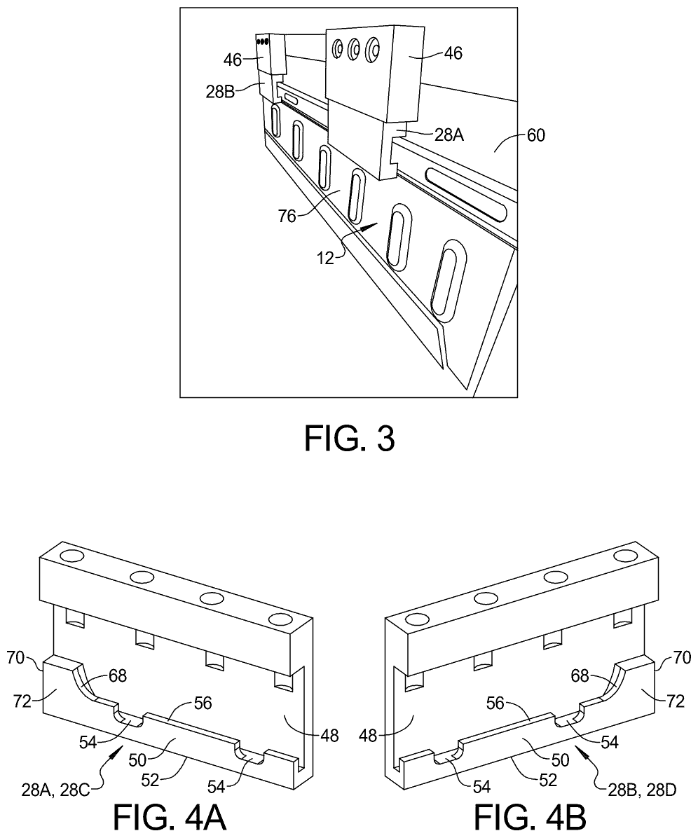

Example embodiments will now be described more fully with reference to the accompanying drawings. Referring to FIG. 1, FIG. 2 and FIG. 3, a lifting tool 10 for battery modules 12 for electric vehicles includes a support arm 14 having a first distal end 16 and a second distal end 18, the first distal end 16 including features 20 adapted for attachment to a lifting mechanism 22. As shown in FIG. 1, the first distal end 16 of the support arm 14 includes an eye formed therein which allows the lifting tool 10 to be attached to a hook 24 of a lifting mechanism 22, such as a hoist, to allow the lifting mechanism 22 to be raised and lowered. The lifting mechanism 22 may be supported on a gantry system (not shown) which allows the lifting mechanism 22 to raise and lower the lifting tool 10, and allows the lifting mechanism 22 and lifting tool 10 to be maneuvered within a work space.

The lifting tool 10 includes a chassis 26 supported on the second distal end 18 of the support arm 14. The chassis 26 includes a plurality of lifting hooks 28A-28D which are adapted to engage engagement features 30 of battery modules 12 for electric vehicles, as shown in FIG. 3. The lifting hooks 28A-28D are adapted to engage different engagement features 30A, 30B of different battery modules 12, thus allowing the lifting tool 10 to be used to lift and maneuver different versions of battery modules 12 without the need to use a unique tool or to swap out lifting hooks on the lifting tool 10. In an exemplary embodiment, each of the plurality of lifting hooks 28A-28D is adapted to engage battery modules 12 having first engagement features 30A, and each of the plurality of lifting hooks 28A-28D is adapted to engage battery modules 12 having second engagement features 30B. Details of the lifting hooks 28A-28D and the first and second engagement features 30A, 30B of the battery modules 12 will be discussed below.

In an exemplary embodiment, the chassis 26 is pivotally supported on the second distal end 18 of the support arm 14 via a pivotal connector 32 to allow the chassis 26 to align with an orientation of a battery module 12. The pivotal connector 32 between the chassis 26 of the lifting tool 10 and the support arm 14 allows the chassis 26 to pivot within both an x-axis and a y-axis, allowing an orientation of the chassis 26 to match an orientation of a battery module 12 when the lifting tool 10 engages a battery module 12. The pivotal connector 32 may comprise a ball and socket type connection or may comprise a dual hinge connection including a first hinge connection allowing pivotal movement within the x-axis and a second hinge connection allowing pivotal movement within the y-axis. Thus, if a battery module 12 is not positioned perfectly level, the chassis 26 will be able to match the orientation of the battery module 12, allowing the lifting hooks 28A-28D of the lifting tool 10 to engage the engagement features 30A, 30B of the battery module 12.

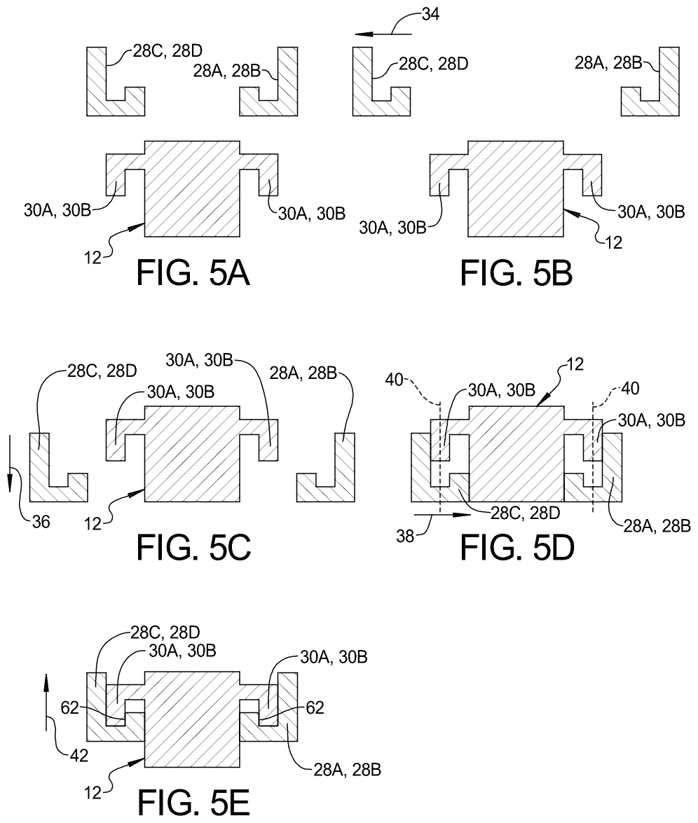

In an exemplary embodiment, the plurality of lifting hooks 28A-28D includes at least one left side lifting hook 28C, 28D and at least one right side lifting hook 28A, 28B, the at least one left side lifting hook 28C, 28D and the at least one right side lifting hook 28A, 28B oriented facing one another and adapted to engage the engagement features 30A, 30B of a battery module 12 therebetween. Referring to FIG. 5A-FIG. 5E, schematic side views of the lifting hooks 28A-28D throughout the engagement process with engagement features 30A, 30B of a battery module 12 are shown. It is to be understood that the first engagement features 30A are unique and separate from the second engagement features 30B and that the first and second engagement features 30A, 30B would not both be present on a single battery module 12. In FIG. 5A-FIG. 5E the first and second engagement features 30A, 30B are generically shown for purposes of illustrating the engagement of the lifting hooks 28A-28D with the first and second engagement features 30A, 30B. Details of the first and second engagement features will be discussed below.

Referring to FIG. 5A, the lifting tool 10 is positioned in proximity above a battery module 12 to be lifted. Referring to FIG. 5B, the at least one left side lifting hook 28C, 28D is laterally moveable relative to the at least one right side lifting hook 28A, 28B, wherein the at least one left side lifting hook 28C, 28D is adapted to be selectively moved away from the at least one right side lifting hook 28A, 28B, as shown by arrow 34, to allow the lifting tool 10 to be positioned onto the battery module 12. Moving the at least one left side lifting hook 28C, 28D away from the at least one right side lifting hook 28A, 28B increases the space between the at least one left side lifting hook 28C, 28D and the at least one right side lifting hook 28A, 28B to “open” the lifting tool 10 and allow the battery module 12 to fit therebetween.

Referring to FIG. 5C, the lifting tool 10 can now be lowered onto the battery module 12, as shown by arrow 36, bringing the lifting hooks 28A-28D to a position below the engagement features 30A, 30B of the battery module 12. When the lifting tool 10 is lowered onto the battery module 12, the chassis 26 may rest on a top surface of the battery module 12, or the lifting tool 10 may remain suspended by the lifting mechanism 22, and lowered to a position where the lifting hooks 28A-28D are positioned below the engagement features 30A, 30B of the battery module 12, as shown in FIG. 5C.

Referring to FIG. 5D, once the lifting tool 10 is lowered onto or relative to the battery module 12, the at least one left side lifting hook 28C, 28D is adapted to be selectively moved toward the at least one right side lifting hook 28A, 28B, as shown by arrow 38, bringing the plurality of lifting hooks 28A-28D into vertical alignment with the engagement features 30A, 30B of the battery module 12 once the lifting tool 10 is positioned onto the battery module, as shown by dashed lines 40. Thus, referring to FIG. 5E, when the lifting tool 10 is raised upward, as shown by arrow 42, the plurality of lifting hooks 28A-28D engage the engagement features 30A, 30B of the battery module 12.

Referring again to FIG. 1 and FIG. 2, in an exemplary embodiment, the lifting tool 10 includes a lever mechanism 44 adapted to allow selective movement of the at least one left side lifting hook 28C, 28D relative to the at least one right side lifting hook 28A, 28B. The lever mechanism 44 may be attached to mechanical linkage or attached to an electronic or pneumatic actuator to allow an individual using the lifting tool 10 to selectively and manually actuate the at least one left side lifting hook 28C, 28D to move the at least one left side lifting hook 28C, 28D toward or away from the at least one right side lifting hook 28A, 28B.

In an exemplary embodiment, the plurality of lifting hooks 28A-28D are electrically isolated from the chassis 26 of the lifting tool 10. Referring again to FIG. 1, FIG. 2 and FIG. 3, the lifting tool 10 includes a plurality of isolating elements 46. One isolating element 46 is positioned between each of the plurality of lifting hooks 28A-28D and the chassis 26 and each of the plurality of isolating elements 46 is made from a non-conductive material. This provides electrical insulation to isolate a battery module 12 that is being lifted from the chassis 26, and an individual using the lifting tool 10. As shown, each of the plurality of isolating elements 46 is mounted onto the chassis 26, and each of the plurality of lifting hooks 28A-28D is mounted onto one of the isolating elements 46. The plurality of isolating elements 46 may be made from any appropriate polymer material or other non-conductive material that provides electrical insulation and adequate strength characteristics. In an exemplary embodiment, each of the plurality of isolating elements 46 is made from Delrin, which is an acetal homopolymer (Polyoxymethylene POM). Delrin is a composite material that provides low-friction and high wear-resistance and strength and stiffness characteristics similar to metals, but is non-conductive.

In an exemplary embodiment, the plurality of lifting hooks 28A-28D are adapted to engage the engagement features 30A-30B of a battery module 12 such that the plurality of lifting hooks 28A-28D cannot be disengaged from the battery module 12 and the battery module 12 cannot move within the lifting tool 10 when the weight of the battery module 12 is being supported by the plurality of lifting hooks 28A-28D.

As shown in FIG. 1, FIG. 2 and FIG. 3, the plurality of lifting hooks 28A-28D includes a first lifting hook 28A, a second lifting hook 28B, a third lifting hook 28C and a fourth lifting hook 28D. The first lifting hook 28A and the second lifting hook 28B are right side lifting hooks, mounted onto a stationary portion 26A of the chassis 26 of the lifting tool 10. The third lifting hook 28C and the fourth lifting hook 28D are left side lifting hooks, mounted onto a moveable portion 26B of the chassis 26 of the lifting tool 10, wherein the moveable portion 26B of the chassis 26 and the third and fourth lifting hooks 28C, 28D may be selectively moved toward and away from the stationary portion 26A of the chassis 26 and the first and second lifting hooks 28A, 28B with the lever mechanism 22, as described above. The second lifting hook 28B and the fourth lifting hook 28D are mirror images of the first lifting hook 28A and the third lifting hook 28C. Referring to FIG. 4A, a perspective view of the first lifting hook 28A and the third lifting hook 28C is shown. Referring to FIG. 4B, the second lifting hook 28B and the fourth lifting hook 28D have substantially identical features but are mirror images of the first and third lifting hooks 28A, 28C.

As shown in FIG. 4A and FIG. 4B, in an exemplary embodiment, each of the plurality of lifting hooks 28A-28D includes a body 48 including features adapted to allow the lifting hook 28A-28D to be attached to one of the plurality of isolating elements 46. An upward lip portion 50 extends laterally along a bottom edge 52 of each lifting hook 28A-28D, the upward lip portion 50 including a pair of notches 54 formed therein, the notches 54 defining a center lip section 56.

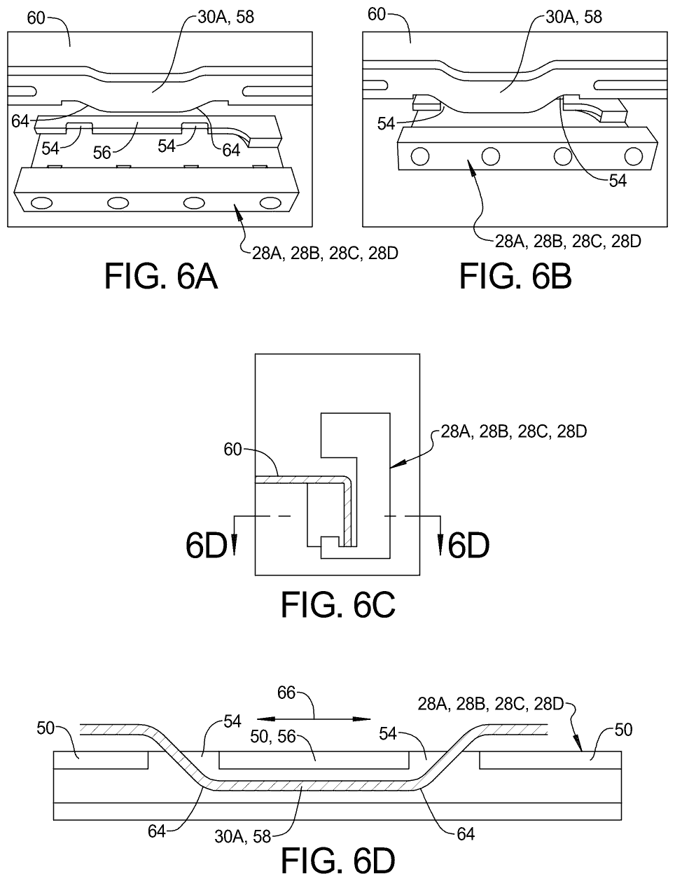

Referring to FIG. 6A, FIG. 6B, FIG. 6C and FIG. 6D, first engagement features 30A of a battery module 12 include a bumped-out portion 58 of a module cover 60. The battery module includes a plurality of first engagement features 30A, engagement features 30A being positioned at locations on the battery module 12 corresponding to each one of the plurality of lifting hooks 28A-28D. The notches 54 are positioned and sized such that the center lip section 56 of the upward lip portion 50 fits within an interior of the corresponding bumped-out portion 58 of the module cover 60. Thus, when the lifting hook 28A-28D engages the bumped-out portion 58 of the module cover 60, the center lip section 56 is received within the bumped-out portion 58 of the module cover 60. The center lip section 56 being positioned within the bumped-out portion 58 of the module cover 60 prevents lateral movement of the lifting hook 28A-28D away from the battery module 12 when the weight of the battery module 12 is supported on the lifting hook 28A-28D. Referring again to FIG. 5E, engagement between the center lip section 56 and the bumped-out portion 58 of the module cover 60 of the battery module 12, as indicated at 62, prevents the lifting hooks 28A-28D from moving laterally away from the battery module 12.

Further, when the lifting hook 28A-28D engages the bumped-out portion 58 of the module cover 60, edges 64 of the bumped-out portion 58 of the module cover 60 are received within the notches 54 formed within the upward lip portion 50 of the lifting hooks 28A-28D, preventing movement of the battery module 12 fore and aft within the lifting tool 10 when the weight of the battery module 12 is supported on the lifting hook 28A-28D. Referring to FIG. 6D, engagement between the edges 64 of the bumped-out portion 58 of the module cover 60 and the notches 54 formed within the upward lip portion 50 of the lifting hooks 28A-28D prevents the bumped-out portion of the module cover 60, and thus the battery module 12, from moving fore and aft, as indicated by arrow 66, relative to the lifting hook 28A-28D, and thus, the lifting tool 10. Thus, once the weight of the battery module 12 is supported on the plurality of lifting hooks 28A-28D, the battery module 12 is locked within the plurality of lifting hooks 28A-28D and cannot be intentionally or inadvertently dislodged from the lifting tool 10.

Referring again to FIG. 4A and FIG. 4B, each of the plurality of lifting hooks 28A-28D further includes a ramped section 68 formed within the upward lip portion 50 near a distal end 70 of the lifting hook 28A-28D. The ramped section 68 defines a tapered hub 72 adjacent the distal end 70 of the lifting hook 28A-28D.

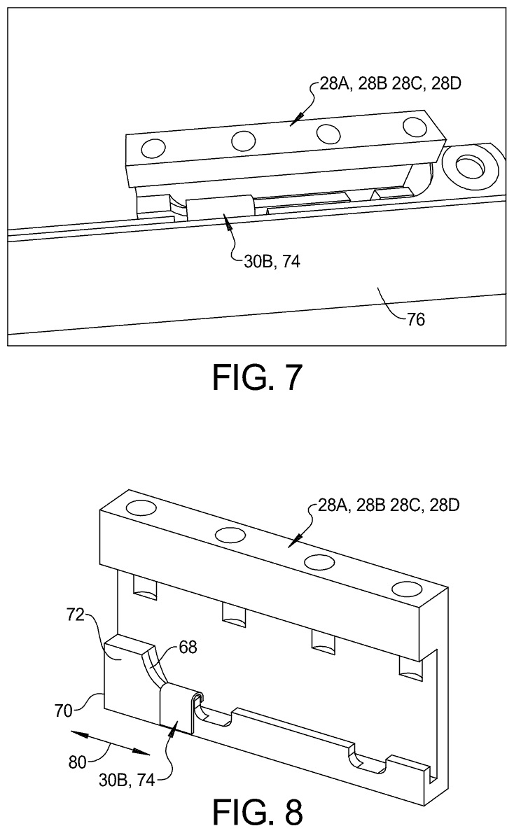

Referring to FIG. 3, FIG. 7 and FIG. 8, second engagement features 30B of a battery module 12 include a downward lip flange 74 extending from a side wall 76 of the battery module 12. The battery module 12 includes a plurality of second engagement features 30B, second engagement features 30B being positioned at locations on the battery module 12 corresponding to each one of the plurality of lifting hooks 28A-28D. FIG. 7 shows the lifting hook 28A-28D engaged with the second engagement features 30B, 74 of the side wall 76 of a battery module 12, wherein the side wall 76 of the battery module 12 has been removed from the battery module 12 for illustration purposes. FIG. 8 shows only the second engagement features 30B (downward lip flange 74, side wall 76 of the battery module 12 removed) engaged with the lifting hook 28A-28D.

When the lifting hook 28A-28D engages the second engagement features 30B, 74 of the side wall 76 of the battery module 12, the tapered hub 72 is engaged with the downward lip flange 74. Referring again to FIG. 5E, engagement of the upward lip portion 50 of the lifting hook 28A-28D with the downward lip flange 74 of the battery module 12, as indicated at 62, prevents lateral movement of the lifting hook 28A-28D away from the battery module 12 when the weight of the battery module 12 is supported on the lifting hook 28A-28D. Further, referring to FIG. 8, the ramped portion 68 of the upward lip portion 50 that defines the tapered hub 72, is engaged with the downward lip flange 74 to prevent movement of the battery module 12 fore and aft, as indicated by arrow 80, within the lifting tool 10. Thus, once the weight of the battery module 12 is supported on the plurality of lifting hooks 28A-28D, the battery module 12 is locked within the plurality of lifting hooks 28A-28D and cannot be intentionally or inadvertently dislodged from the lifting tool 10.

The locking feature of the first engagement features 30A and the second engagement features 30B provides automatic locking of the battery module 12 within the plurality of lifting hooks 28A-28D. Thus, the battery module 12 is automatically locked in place, and cannot, either intentionally or inadvertently, be dislodged from the lifting tool 10 once the weight of the battery module 12 is supported by the plurality of lifting hooks 28A-28D. Even if an operator attempts, using the lever mechanism 44, to release the lifting tool 10 from the battery module 12, as long as the weight of the battery module 12 is supported by the plurality of lifting hooks 28A-28D, the operator will be unable to do so. The automatic nature of this locking feature ensures that an operator of the lifting tool 10 cannot forget to lock the battery module 12 within the lifting tool 10 prior to lifting, and ensures that the battery module 12 can be moved from one location to another, within the lifting tool 10, without the battery module 12 being dislodged.

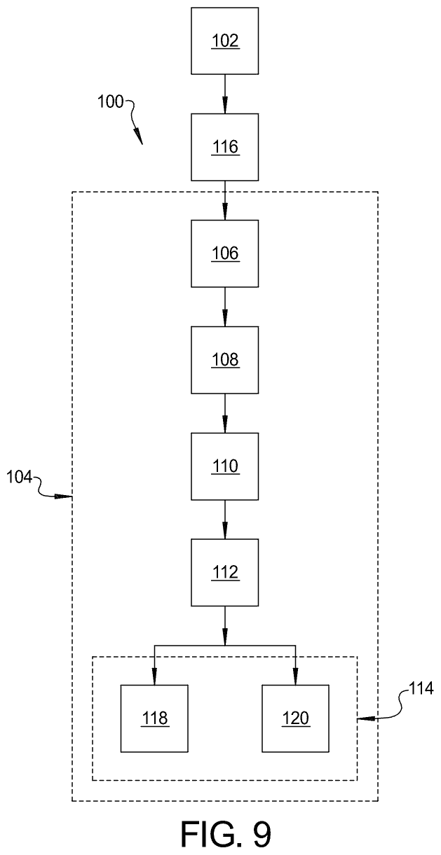

Referring to FIG. 9, a method of utilizing a lifting tool 10 for battery modules 12 for electric vehicles is shown at 100. The method 100 includes, beginning at block 102, attaching a first distal end 16 of a support arm 14 of the lifting tool 10 to a lifting mechanism 22, and, moving to block 104, engaging engagement features 30A, 30B of a battery module 12 with a plurality of lifting hooks 28A-28D mounted onto a chassis 26 that is supported on a second distal end 18 of the support arm 14, wherein, each of the plurality of lifting hooks 28A-28D is adapted to engage battery modules 12 having first engagement features 30A, and adapted to engage battery modules 12 having second engagement features 30B.

In an exemplary embodiment, the engaging engagement features 30A, 30B of a battery module 12 with a plurality of lifting hooks 28A-28D mounted onto a chassis 26 that is supported on a second distal end 18 of the support arm 14 at block 104 further includes, moving to block 106, aligning the chassis 26 with an orientation of the battery module 12 via a pivotal connector 32 between the chassis 26 and the second distal end 18 of the support arm 14.

In another exemplary embodiment, the plurality of lifting hooks 28A-28D includes at least one left side lifting hook 28C, 28D and at least one right side lifting hook 28A, 28B, the at least one left side lifting hook 28C, 28D and the at least one right side lifting hook 28A, 28B oriented facing one another and adapted to engage the engagement features 30A, 30B of a battery module 12 therebetween, wherein the at least one left side lifting hook 280, 28D is laterally moveable relative to the at least one right side lifting hook 28A, 28B, wherein the engaging engagement features 30A, 30B of a battery module 12 with a plurality of lifting hooks 28A-28D mounted onto a chassis 16 that is supported on a second distal end 18 of the support arm 14 at block 104 further includes, moving to block 108, selectively moving the at least one left side lifting hook 28C, 28D away from the at least one right side lifting hook 28A, 28B to allow the lifting tool 10 to be positioned onto a battery module 12, moving to block 110, lowering the lifting tool 10 onto the battery module 12, moving to block 112, selectively moving the at least one left side lifting hook 28C, 28D toward the at least one right side lifting hook 28A, 28B and bringing the plurality of lifting hooks 28A-28D into vertical alignment with engagement features 30A, 30B of the battery module 12, and, moving to block 114, raising the lifting tool 10 upward and engaging the plurality of lifting hooks 28A-28D with the engagement features 30A, 30B of the battery module 12.

In another exemplary embodiment, the selectively moving the at least one left side lifting hook 28C, 28D at blocks 108 and 112, further includes selectively moving the at least one left side lifting hook 28C, 28D by selectively actuating a lever mechanism 44 adapted to move the at least one left side lifting hook 28C, 28D relative to the at least one right side lifting hook 28A, 28B.

In another exemplary embodiment, the method 100 further includes, moving to block 116, positioning an isolating element 46, made from a non-conductive polymer material, between each of the plurality of lifting hooks 28A-28D and the chassis 26.

In another exemplary embodiment, the plurality of lifting hooks 28A-28D includes a first lifting hook 28A, a second lifting hook 28B, a third lifting hook 28C and a fourth lifting hook 28D, wherein the first lifting hook 28A and the second lifting hook 28B are right side lifting hooks, the third lifting hook 28C and the fourth lifting hook 28D are left side lifting hooks, and the second lifting hook 28B and the fourth lifting hook 28D are mirror images of the first lifting hook 28A and the third lifting hook 28C, each of the plurality of lifting hooks 28A-28D including a body 48 including features adapted to allow the lifting hook 28A-28D to be attached to an isolating element 46 and an upward lip portion 50 extending laterally along a bottom edge 52 of the lifting hook 28A-28D, the upward lip portion 50 including a pair of notches 54 formed therein, the notches 54 defining a center lip section 56, wherein, the raising the lifting tool 10 upward and engaging the plurality of lifting hooks 28A-28D with engagement features 30A, 30B of a battery module 12 at block 114 further includes, moving to block 118, raising the lifting tool 10 upward, and, for each of the plurality of lifting hooks 28A-28D, receiving, within first engagement features 30A that include a bumped-out portion 58 of a module cover 60 of the battery module 12, the center lip section 56 of the lifting hook 28A-28D, thereby preventing lateral movement of the lifting hook 28A-28D away from the battery module 12 when the weight of the battery module 12 is supported on the lifting hook 28A-28D, and, preventing movement of the battery module 12 fore and aft within the lifting tool 10, thereby locking the battery module 12 within the plurality of lifting hooks 28A-28D and preventing the battery module 12 from being dislodged from the lifting tool 10.

In another exemplary embodiment, each of the plurality of lifting hooks 28A-28D further includes a ramped section 68 formed within the upward lip portion 50 near a distal end 70 of the lifting hook 28A-28D and defining a tapered hub 72 adjacent the distal end 70 of the lifting hook 28A-28D, wherein, the raising the lifting tool 10 upward and engaging the plurality of lifting hooks 28A-28D with engagement features 30A, 30B of a battery module 12 at block 114 further includes, moving to block 120, raising the lifting tool 10 upward, and, for each of the plurality of lifting hooks 28A-28D, engaging, with second engagement features 30B including a downward lip flange 74 extending from a side wall 76 of the battery module 12, the tapered hub 72, and engaging the upward lip portion 50 of the lifting hook 28A-28D with the downward lip flange 74 of the corresponding secondary engagement feature 30B of the battery module 12 and preventing lateral movement of the lifting hook 28A-28D away from the battery module 12 when the weight of the battery module 12 is supported on the lifting hook 28A-28D, and preventing, with the ramped portion 68 of the upward lip portion 50 that defines the tapered hub 72 engaged with the downward lip flange 74, movement of the battery module 12 fore and aft within the lifting tool 10, thereby locking the battery module 12 within the plurality of lifting hooks 28A-28D and preventing the battery module 12 from being dislodged from the lifting tool 10.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A lifting tool for battery modules for electric vehicles, comprising:
a support arm having a first distal end and a second distal end, the first distal end including features adapted for attachment to a lifting mechanism; and
a chassis supported on the second distal end of the support arm and including a plurality of lifting hooks adapted to engage engagement features of battery modules for electric vehicles; and
wherein, each of the plurality of lifting hooks is adapted to engage battery modules having first engagement features, and adapted to engage battery modules having second engagement features.

2. The lifting tool of claim 1, wherein the chassis is pivotally supported on the second distal end of the support arm to allow the chassis to align with an orientation of a battery module.

3. The lifting tool of claim 2, wherein the plurality of lifting hooks includes at least one left side lifting hook and at least one right side lifting hook, the at least one left side lifting hook and the at least one right side lifting hook oriented facing one another and adapted to engage the engagement features of a battery module therebetween.

4. The lifting tool of claim 3, wherein the at least one left side lifting hook is laterally moveable relative to the at least one right side lifting hook, wherein the at least one left side lifting hook is adapted to be:
selectively moved away from the at least one right side lifting hook to allow the lifting tool to be positioned onto a battery module, and
selectively moved toward the at least one right side lifting hook bringing the plurality of lifting hooks into vertical alignment with engagement features of the battery module once the lifting tool is positioned onto the battery module; and
wherein, when the lifting tool is raised upward the plurality of lifting hooks engage the engagement features of the battery module.

5. The lifting tool of claim 4 further including a lever mechanism adapted to allow selective movement of the at least one left side lifting hook relative to the at least one right side lifting hook.

6. The lifting tool of claim 5, wherein the plurality of lifting hooks are adapted to engage the engagement features of a battery module such that the plurality of lifting hooks cannot be disengaged from the battery module and the battery module cannot move within the lifting tool when the weight of the battery module is being supported by the plurality of lifting hooks.

7. The lifting tool of claim 6, wherein the plurality of lifting hooks are electrically isolated from the chassis of the lifting tool.

8. The lifting tool of claim 7, further including a plurality of isolating elements, one isolating element positioned between each of the plurality of lifting hooks and the chassis and each of the plurality of isolating elements made from a non-conductive material.

9. The lifting tool of claim 8, wherein the plurality of isolating elements are made from a polymer material.

10. The lifting tool of claim 9, wherein the plurality of lifting hooks includes a first lifting hook, a second lifting hook, a third lifting hook and a fourth lifting hook, wherein:
the first lifting hook and the second lifting hook are right side lifting hooks;
the third lifting hook and the fourth lifting hook are left side lifting hooks; and
the second lifting hook and the fourth lifting hook are mirror images of the first lifting hook and the third lifting hook.

11. The lifting tool of claim 10, wherein each of the plurality of lifting hooks includes:
a body including features adapted to allow the lifting hook to be attached to one of the plurality of isolating elements;
an upward lip portion extending laterally along a bottom edge of the lifting hook, the lip portion including a pair of notches formed therein, the notches defining a center lip section;
wherein, first engagement features of a battery module include a bumped out portion of a module cover, and when the lifting hook engages the bumped out portion of the module cover, the center lip section is received within the bumped out portion of the module cover, preventing lateral movement of the lifting hook away from the battery module when the weight of the battery module is supported on the lifting hook, and, preventing movement of the battery module fore and aft within the lifting tool, thereby locking the battery module within the plurality of lifting hooks and preventing the battery module from being dislodged from the lifting tool.

12. The lifting tool of claim 11, wherein each of the plurality of lifting hooks further includes a ramped section formed within the lip portion near a distal end of the lifting hook and defining a tapered hub adjacent the distal end of the lifting hook;
wherein, second engagement features of a battery module include a downward lip flange extending from a side wall of the battery module, and when the lifting hook engages the second engagement features of the side wall of the battery module, the tapered hub is engaged with the downward lip flange, wherein engagement of the upward lip of the lifting hook with the downward lip flange of the battery module prevents lateral movement of the lifting hook away from the battery module when the weight of the battery module is supported on the lifting hook, and, the tapered hub, engaged with the downward lip flange prevents movement of the battery module fore and aft within the lifting tool, thereby locking the battery module within the plurality of lifting hooks and preventing the battery module from being dislodged from the lifting tool.

13. A method of utilizing a lifting tool for battery modules for electric vehicles, comprising:
attaching a first distal end of a support arm of the lifting tool to a lifting mechanism; and
engaging engagement features of a battery module with a plurality of lifting hooks mounted onto a chassis that is supported on a second distal end of the support arm; and
wherein, each of the plurality of lifting hooks is adapted to engage battery modules having first engagement features, and adapted to engage battery modules having second engagement features.

14. The method of claim 13, wherein the engaging engagement features of a battery module with a plurality of lifting hooks mounted onto a chassis that is supported on a second distal end of the support arm further includes aligning the chassis with an orientation of the battery module via a pivotal connection between the chassis and the second distal end of the support arm.

15. The method of claim 14, wherein the plurality of lifting hooks includes at least one left side lifting hook and at least one right side lifting hook, the at least one left side lifting hook and the at least one right side lifting hook oriented facing one another and adapted to engage the engagement features of a battery module therebetween, wherein the at least one left side lifting hook is laterally moveable relative to the at least one right side lifting hook;
the engaging engagement features of a battery module with a plurality of lifting hooks mounted onto a chassis that is supported on a second distal end of the support arm further including:
selectively moving the at least one left side lifting hook away from the at least one right side lifting hook to allow the lifting tool to be positioned onto a battery module;
lowering the lifting tool onto the battery module;
selectively moving the at least one left side lifting hook toward the at least one right side lifting hook and bringing the plurality of lifting hooks into vertical alignment with engagement features of the battery module; and
raising the lifting tool upward and engaging the plurality of lifting hooks with the engagement features of the battery module.

16. The method of claim 15 wherein the selectively moving the at least one left side lifting hook further includes selectively moving the at least one left side lifting hook by selectively actuating a lever mechanism adapted to move the at least one left side lifting hook relative to the at least one right side lifting hook.

17. The method of claim 16, further including positioning an isolating element, made from a non-conductive polymer material, between each of the plurality of lifting hooks and the chassis.

18. The method of claim 17, wherein the plurality of lifting hooks includes a first lifting hook, a second lifting hook, a third lifting hook and a fourth lifting hook, wherein the first lifting hook and the second lifting hook are right side lifting hooks, the third lifting hook and the fourth lifting hook are left side lifting hooks, and the second lifting hook and the fourth lifting hook are mirror images of the first lifting hook and the third lifting hook, each of the plurality of lifting hooks including a body including features adapted to allow the lifting hook to be attached to an isolating element and an upward lip portion extending laterally along a bottom edge of the lifting hook, the lip portion including a pair of notches formed therein, the notches defining a center lip section;
wherein, the raising the lifting tool upward and engaging the plurality of lifting hooks with engagement features of a battery module further includes:
raising the lifting tool upward; and
for each of the plurality of lifting hooks, receiving, within first engagement features that include a bumped out portion of a module cover of the battery module, the center lip section of the lifting hook, thereby preventing lateral movement of the lifting hook away from the battery module when the weight of the battery module is supported on the lifting hook, and, preventing movement of the battery module fore and aft within the lifting tool, thereby locking the battery module within the plurality of lifting hooks and preventing the battery module from being dislodged from the lifting tool.

19. The method of claim 18, wherein each of the plurality of lifting hooks further includes a ramped section formed within the lip portion near a distal end of the lifting hook and defining a tapered hub adjacent the distal end of the lifting tool;
wherein, the raising the lifting tool upward and engaging the plurality of lifting hooks with engagement features of a battery module further includes:
raising the lifting tool upward; and
for each of the plurality of lifting hooks:
engaging, with second engagement features including a downward lip flange extending from a side wall of the battery module, the tapered hub;
engaging the upward lip of the lifting hook with the downward lip flange of the battery module and preventing lateral movement of the lifting hook away from the battery module when the weight of the battery module is supported on the lifting hook; and
preventing, with the tapered hub engaged with the downward lip flange, movement of the battery module fore and aft within the lifting tool, thereby locking the battery module within the plurality of lifting hooks and preventing the battery module from being dislodged from the lifting tool.

20. A lifting tool for battery modules for electric vehicles, comprising:
a support arm having a first distal end and a second distal end, the first distal end including features adapted for attachment to a lifting mechanism;
a chassis pivotally supported on the second distal end of the support arm;
a first lifting hook, a second lifting hook, a third lifting hook and a fourth lifting hook supported on the chassis and adapted to engage engagement features of battery modules for electric vehicles, wherein:
the first lifting hook and the second lifting hook are right side lifting hooks;
the third lifting hook and the fourth lifting hook are left side lifting hooks;
the second lifting hook and the fourth lifting hook are mirror images of the first lifting hook and the third lifting hook, the first and second lifting hook are oriented facing the third and fourth lifting hook and are adapted to engage the engagement features of a battery module therebetween; and
the third and fourth lifting hooks laterally moveable relative to the first and second lifting hooks, wherein the third and fourth lifting hooks are adapted to be selectively moved away from the first and second lifting hooks to allow the lifting tool to be positioned onto a battery module, and to be selectively moved toward the first and second lifting hooks bringing the first, second, third and fourth lifting hooks into vertical alignment with engagement features of the battery module once the lifting tool is positioned onto the battery module, wherein, when the lifting tool is raised upward the first, second, third and fourth lifting hooks are adapted to engage battery modules having first engagement features, and adapted to engage battery modules having second engagement features;
a lever mechanism adapted to allow selective movement of the at least one left side lifting hook relative to the at least one right side lifting hook;
a plurality of isolating elements, one isolating element positioned between each of the plurality of lifting hooks and the chassis and each of the plurality of isolating elements made from a non-conductive polymer material;
wherein, each of the first, second, third and fourth lifting hooks includes:
a body including features adapted to allow the lifting hook to be attached to the isolating element;
an upward lip portion extending laterally along a bottom edge of the lifting hook, the lip portion including a pair of notches formed therein, the notches defining a center lip section; and
a ramped section formed within the lip portion near a distal end of the lifting hook and defining a tapered hub adjacent the distal end of the lifting tool;
wherein, first engagement features of a battery module include a bumped out portion of a module cover, and when the lifting hook engages the bumped out portion of the module cover, the center lip section is received within the bumped out portion of the module cover, preventing lateral movement of the lifting hook away from the battery module when the weight of the battery module is supported on the lifting hook, and, preventing movement of the battery module fore and aft within the lifting tool, thereby locking the battery module within the plurality of lifting hooks and preventing the battery module from being dislodged from the lifting tool; and
wherein, second engagement features of a battery module include a downward lip flange extending from a side wall of the battery module, and when the lifting hook engages the second engagement features of the side wall of the battery module, the tapered hub engages the downward lip flange, wherein engagement of the upward lip of the lifting hook with the downward lip flange of the battery module prevents lateral movement of the lifting hook away from the battery module when the weight of the battery module is supported on the lifting hook, and, the tapered hub, engaged with the downward lip flange prevents movement of the battery module fore and aft within the lifting tool, thereby locking the battery module within the plurality of lifting hooks and preventing the battery module from being dislodged from the lifting tool.
